(19) United States
(12) Patent Application Publication
(10) Pub. No.: US 2023/0320520 A1
(43) Pub. Date: Oct. 12, 2023

(54) METHOD FOR SWEETENING A MILK-CONTAINING FLUID, DISPENSING DEVICE, SWEETENING UNIT AND USE OF A SWEETENING UNIT

(71) Applicant: Jura Elektroapparate AG, Niederbuchsiten (CH)

(72) Inventor: Christoph GROB, Zofingen (CH)

(73) Assignee: Jura Elektroapparate AG, Niederbuchsiten (CH)

(21) Appl. No.: 18/025,005

(22) PCT Filed: Jul. 29, 2021
(86) PCT No.: PCT/EP2021/071349

§ 371 Date: Mar. 7, 2023

(30) Foreign Application Priority Data
Sep. 30, 2020 (EP) 20199474.6

(51) Int. Cl. A47J 31/46; A47J 31/44

(52) U.S. Cl. CPC A47J 31/462; A47J 31/4485; A47J 31/4489

(57) ABSTRACT

A method for sweetening a milk-containing fluid, in which the milk-containing fluid is passed through a sweetener. To this end, a sweetening unit (1) for a dispensing device (2) can be used, in which a fluid inlet (4) and a fluid outlet (5) are designed such that a fluid flow through the sweetener can be generated. The sweetening unit (1) can preferably be placed removably on a milk outlet (20) of a milk delivery unit (19).

### CROSS-REFERENCE TO RELATED APPLICATIONS

This application is a 371 National Phase of PCT/EP2021/071349, filed Jul. 29, 2021, which claims the benefit of European Patent Application NO. 20199474.6, filed Sep. 30, 2019.

### TECHNICAL FIELD

The invention relates to a method for sweetening a milk-containing fluid. Methods of this type are known in practice. For example, it is known to add a sweetening means, such as sugar, to milk and then to add the sweetened milk to a hot beverage, for example coffee.

The invention furthermore relates to a sweetening unit for a dispensing device for a milk-containing fluid, wherein the sweetening unit comprises a container for a sweetening means, a fluid inlet and a fluid outlet. Sweetening units of this type are known in practice. In the case of fully automatic coffee machines it is known, for example, to provide a flavor station which comprises a container for a sweetening means, a fluid inlet and a fluid outlet, wherein, in the flavor station, the sweetening means is actively mixed into a fluid conducted through the latter.

The invention furthermore relates to a dispensing device for a milk-containing fluid having a sweetening unit and a basic appliance, wherein the basic appliance comprises a milk-conducting unit with a milk outlet for a milk-containing fluid. Fully automatic coffee machines having these technical features already exist on the market.

The invention also relates to the use of a sweetening unit on a dispensing device for a milk-containing fluid for sweetening the milk-containing fluid.

### SUMMARY

The invention is based on the object of improving the process of sweetening a milk-containing fluid and the sweetening result.

To achieve this object, one or more of the features disclosed herein are used. In particular, it is therefore proposed, according to the invention, in the case of a method for sweetening a milk-containing fluid, for achieving the object mentioned that the milk-containing fluid is conducted through a sweetening means. The milk-containing fluid is preferably conducted through a container filled with a sweetening means. The milk-containing fluid can be, for example, liquid milk, a milk/air mixture, frothed milk or another fluid having a milk portion. A fluid here can be characterized by having a gaseous or liquid state or any desired intermediate form.

The invention therefore makes provision that the conventional principle of adding the sweetening means to a milk-containing fluid is reversed. In a reversal of this principle, according to the invention the milk-containing fluid is conducted through the sweetening means. The effect which can be achieved by this is that the milk-containing fluid is sweetened homogeneously and in a readily controllable way.

The process of conducting it through a sweetening means can be characterized by the fact that the milk-containing fluid is conducted through a volume which is occupied by the substance of which the sweetening means is composed. If the sweetening means therefore surrounds, for example, a cavity filled with air and the milk-containing fluid is conducted through the cavity, the milk-containing fluid is not conducted through the sweetening means itself, but rather through a volume which lies outside the sweetening means.

If the sweetening means consist, for example, of small grains, the fluid is conducted through the sweetening means if it is conducted into the volume enclosed by the grains and emerges again out of said volume. The sweetening means preferably has properties of a fluid. For example, liquid sweetening means, but also granular sweetening means have such properties. Alternatively or additionally, provision can be made for the sweetening means not to be dimensionally stable. In the previously mentioned cases, no cavity can form in a volume occupied by the sweetening means and the volume occupied by the sweetening means has a delimited area upward. The volume can be delimited downward against the sweetening means trickling out, for example by means of a base of a container. The lower delimitation and the area of the sweetening means delimit a volume occupied by the sweetening means. In such a case, the conducting of the milk-containing fluid through the sweetening means comprises the milk-containing fluid entering the volume and emerging again from said volume.

In a preferred refinement of the method, provision can be made that a viscosity of the milk-containing fluid is lower than a viscosity of the sweetening means. This facilitates the conducting of the fluid through the sweetening means.

Alternatively or additionally, provision can be made that milk for forming the milk-containing fluid is first of all frothed before it is conducted into the container. Preferably, for frothing the milk, a negative pressure is produced by means of steam using the Venturi effect, and therefore milk and air are drawn in and the air/milk mixture is frothed in a mixing chamber. The milk is preferably heated by means of the steam.

In a further advantageous refinement of the method, provision can be made that the milk-containing fluid is injected into the container or is conducted into the container at high speed, and therefore the milk-containing fluid is conducted through the sweetening means. The injecting or conducting in at high speed can be readily metered and therefore controlled conducting through the sweetening means is achieved.

In a further advantageous refinement of the method, provision can be made that the milk-containing fluid entering the container is deflected by a flow obstacle. The milk-containing fluid here preferably undergoes a reversal in direction before it emerges out of the container. The flow obstacle can be formed, for example, by a wall, a partition and/or a base of the container. The deflection and the reversal in direction are required for thoroughly mixing the milk-containing fluid with the sweetening means.

In a further advantageous refinement of the method, provision can be made that the milk-containing fluid is conducted through the sweetening means in such a manner that, after entering the sweetening means, it leaves the latter again upward. Alternatively or additionally, provision can be made that the milk-containing fluid is injected or conducted into the container in such a manner that, upon entry, it is directed downward and/or does not have a speed component upward. Such refinements can further promote the thorough mixing of milk-containing fluid and sweetening means.

In a further advantageous refinement of the method, provision can be made that the sweetening means is a liquid sweetening means. For example, the sweetening means can be a syrup. Alternatively or additionally, provision can be made that the sweetening means is a solid. For example, the sweetening means can be crystalline sugar. Alternatively or additionally, provision can furthermore be made that the sweetening means does not have dimensional stability. For example, liquid sweetening means or a sugar consisting of crystalline grains has this property.

In a further advantageous refinement of the method, provision can be made that the sweetening means is at rest when the milk-containing fluid is conducted therein. By this means, for example, the provision of the sweetening means can be facilitated.

To achieve the object mentioned, according to the invention the features directed toward a sweetening unit are provided. In particular, to achieve the object mentioned, according to the invention it is therefore proposed, in the case of a sweetening unit of the type described at the beginning, that the fluid inlet and the fluid outlet are designed in such a manner that a fluid flow through the sweetening means can be produced. The fluid outlet is preferably designed as an overflow. Furthermore, the container is preferably in the form of a trough. The dispensing device is preferably a fully automatic coffee machine and/or a milk frother. The effect which can be achieved by being able to form a fluid flow between the fluid inlet and the fluid outlet is that a milk-containing fluid can be conducted through a sweetening means located in the container. The advantages in this regard have already been described further above.

If the fluid outlet is designed as an overflow, the container can be filled with sweetening means up to a filling level which lies below the overflow. If milk-containing fluid is now conducted into the container and through the sweetening means, it can leave the container again via the overflow. This can also be undertaken by the fact that, by conducting in the milk-containing fluid, the filling level in the container increases and that milk-containing fluid which then passes upward and is enriched with the sweetening means leaves the container again via the overflow.

In an advantageous refinement of the sweetening unit, provision can be made that the fluid outlet is designed as an overflow collar which protrudes upward from a base of the sweetening unit. The overflow collar is preferably cylindrical and/or designed such that the flow can pass around it on all sides. Furthermore, the overflow collar is preferably completely closed to the side at least in a lower region and/or is open above the closed region and/or open at the bottom. In particular, the aforementioned overflow can be designed as such an overflow collar. Such a refinement of the fluid outlet has the advantage that sweetening means can be arranged around it and the milk-containing fluid can be conducted in a controlled manner through the sweetening means.

In a further advantageous refinement of the sweetening unit, provision can be made that the fluid inlet is designed as an inlet collar which protrudes upward from a base of the sweetening unit, for example the base already mentioned previously, and is not completely closed to the side at least in one region. The inlet collar is preferably cylindrical. Furthermore, the inlet collar is preferably open upward on the inlet side and closed downward. Alternatively or additionally, provision can be made that the fluid inlet has at least one slot. The slot preferably runs vertically. Furthermore, the slot is preferably formed laterally in an inlet collar, for example in the inlet collar already mentioned previously. Such refinements have the advantage that the milk-containing fluid can be injected in a controlled manner and at high pressure into the container and therefore into the sweetening means.

In a further advantageous refinement of the sweetening unit, provision can be made that the fluid inlet has an inwardly bent rim at its upper end. The rim is preferably beveled on the upper side. Alternatively or additionally, provision can be made that the fluid inlet has an elastic cross section at least at a free end.

It can be provided that the fluid inlet protrudes upward higher than the fluid outlet. The fluid inlet is preferably designed in this regard as an inlet collar. The effect which can be achieved by this is that the injection region is increased.

Alternatively or additionally, provision can be made that the overflow is spaced apart on all sides from a lateral border of the sweetening unit. Preferably, the overflow here does not form edges on the outer side and/or the lateral border does not form edges on the inner side. Such refinements assist a deflection and a reversal in direction of a milk-containing fluid introduced into the container.

In one refinement of the sweetening unit, provision can be made that a first sidewall of the overflow adjoins a side edge of a first opening of the fluid inlet flush on the outer side. Preferably, a second sidewall opposite the first sidewall adjoins a side edge of a second opening of the fluid inlet flush on the outer side. Fluid conducted through the opening or openings can be guided here along the sidewall and therefore deflected in the desired way.

In a further advantageous refinement of the sweetening unit, provision can be made that a slot, preferably the previously mentioned slot, in the fluid inlet is upwardly closed. Preferably, the slot ends below an upper end of the fluid outlet. Splashes can thus be prevented from entering the fluid outlet. However, provision can also be made that the slot protrudes upward over the fluid outlet. The boundary of the slot upward has the advantage that splashes which could otherwise soil the dispensing device upward can be avoided. On the one hand, the distance upward is larger. On the other hand, the sweetening means can be filled in the container as far as above the slot, and therefore milk-containing fluid conducted through the slot first of all enters the sweetening means, as a result of which it is likewise prevented that splashes emerge upward at all out of the sweetening means.

Provision can be made that the fluid inlet and the fluid outlet are spaced apart from each other. Said spacing apart can be advantageous since a free path of the fluid flow through the sweetening means can thereby be increased.

Provision can be made that the fluid inlet and the fluid outlet merge into each other. A region of the overflow collar preferably at the same time forms a region of the inlet collar. Such refinements have the advantage that emergence of a milk-containing fluid conducted therein requires the fluid to be reversed in direction, thus improving the thorough mixing.

In a further advantageous refinement of the sweetening unit, provision can be made that the latter has an open cover. The sweetening unit preferably has an open cover in the region of the fluid inlet.

In a further preferred variant, the cover and/or the sweetening unit has an opening for filling the sweetening unit with a sweetening means.

The existence of a cover has the advantage that splashes occurring inside the container cannot soil the dispensing device. As a result of the opening the sweetening means can also be filled into the container without removal of the cover or activation of an opening mechanism.

In order to prevent splashes from emerging out of an opening in the cover, the cover can have a mechanism with which the container is openable and closable. For example, the cover can have a flap. The container can be opened by means of the mechanism in order to fill the container with sweetening means and, after filling, can be closed again. The cover is preferably completely closable by means of the mechanism apart from a possible opening for the fluid inlet.

In a further advantageous refinement of the sweetening unit, provision can be made that a partition is formed in the container so as to only partially close the latter. The partition preferably closes the container for the most part. In particular, provision can be made that the opening forms a gap. Furthermore, the partition preferably leaves an opening in the container downward and/or laterally. Furthermore, preferably, the fluid inlet and the fluid outlet are formed on the same side of the partition. The partition can lead to sweetening means located on the far side of the partition not running back too rapidly and could lead to pure sweetening means emerging from the fluid outlet arranged on this side of the partition.

To achieve the object mentioned, according to the invention the features of the further independent claim directed toward a dispensing device for a milk-containing fluid are provided. In particular, to achieve the object mentioned, according to the invention it is therefore proposed, in the case of a dispensing device of the type described at the beginning, that the sweetening unit can be placed or is placed on the milk outlet and, according to the invention, is designed in particular as previously described and/or as claimed in one of the claims directed towards a sweetening unit. The sweetening unit is preferably removable again. This has the advantage that the dispensing device, which can be in particular a fully automatic coffee machine, remains usable even without a sweetening unit, but the latter can optionally also be usable.

In an advantageous refinement of the dispensing device, provision can be made that the milk-conducting unit comprises a milk frothing apparatus. Alternatively or additionally, provision can be made that the sweetening unit can be placed on or is placed on pivotably. Preferably, a pivot axis is formed here by an axis of the milk outlet. Such refinements have the advantage that the sweetening unit is refillable and/or can be cleaned in a simple manner.

To achieve the object mentioned, according to the invention the features directed toward the use of a sweetening unit are provided. In particular, to achieve the object mentioned, it is therefore proposed according to the invention, in the case of the use of a sweetening unit, that the sweetening unit is used on a dispensing device for a milk-containing fluid for sweetening the milk-containing fluid. According to the invention, the sweetening unit here is designed in particular as previously described and/or as claimed in one of the claims directed toward a sweetening unit. Preferably, according to the invention, the dispensing device is furthermore designed in particular as described previously and/or as claimed in one of the claims directed toward a dispensing device. The dispensing device is preferably a fully automatic coffee machine. The sweetening unit is preferably used in a method which, according to the invention, is designed in particular as described previously and/or as claimed in one of the claims directed toward a method for sweetening a milk-containing fluid.

### BRIEF DESCRIPTION OF THE DRAWINGS

The invention will now be described in more detail with reference to a few exemplary embodiments, but is not restricted to said few exemplary embodiments. Further invention variants and exemplary embodiments emerge by combining the features of individual claims or a plurality of claims with one another and/or with individual features or a plurality of features of the exemplary embodiments and/or of the previously described variants of devices and methods according to the invention.

In the figures:

FIG. 1A and FIG. 1B show a dispensing device in the form of a milk frother with a sweetening unit placed thereon,

FIG. 2A to FIG. 2C show a first exemplary embodiment of a sweetening unit according to the invention,

FIG. 3A to FIG. 3D show a further exemplary embodiment of a sweetening unit according to the invention,

FIG. 4 shows a further exemplary embodiment of a sweetening unit according to the invention,

FIG. 5 shows a further exemplary embodiment of a sweetening unit according to the invention with a cover,

FIG. 6 shows a further exemplary embodiment of a sweetening unit according to the invention with a cover,

FIG. 7A to FIG. 7B show an exemplary embodiment of a sweetening unit according to the invention with a cover and partition,

FIG. 8A to FIG. 8B show a further exemplary embodiment of a sweetening unit according to the invention with a cover and partition,

FIG. 9A to FIG. 9B show a further exemplary embodiment of a sweetening unit according to the invention with a cover and partition, and

FIG. 10A to FIG. 10B show a further exemplary embodiment of a sweetening unit according to the invention with a foldable cover.

### DETAILED DESCRIPTION

In the description below of the invention, elements corresponding in their function receive corresponding reference numbers even if the design or shaping differs.

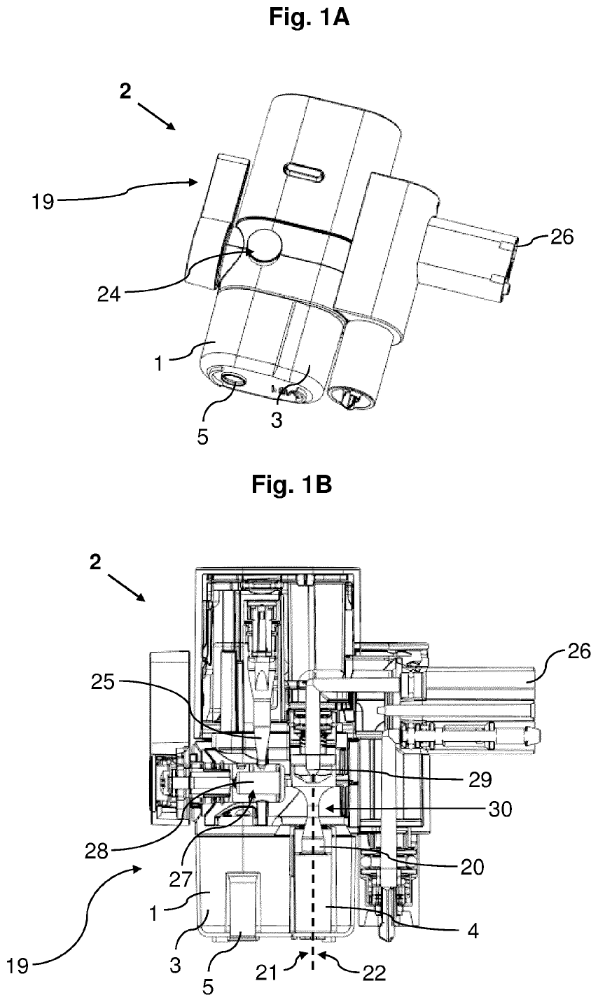

FIG. 1A shows, in a perspective view, a dispensing device 2 which is designed as a milk frothing apparatus, said dispensing device being designed according to the invention. FIG. 1B shows a sectional illustration of said dispensing device 2. The dispensing device 2 is part of a fully automatic coffee machine which also forms a dispensing device 2 overall. The dispensing device 2 has a sweetening unit 1 which is attached removably to the dispensing device 2. Milk frothed during operation is conducted into the container 3 of the sweetening unit 1 via the milk outlet 20. The sweetening unit 1 is attached here to the dispensing device 2 in such a manner that it can be pivoted about the axis 22 of the milk outlet 20. The axis 22 of the milk outlet 20 therefore forms a pivot axis 21 of the sweetening unit 1.

If the sweetening unit 1 is pivoted to the side, sweetening means can be filled into the container 3 of the sweetening unit 1. If the sweetening unit 1 is then pivoted back into a use position, the frothed milk can be conducted through the container 3 and through the sweetening means in the container 3, and therefore the milk is sweetened. The sweetened milk then emerges through the fluid outlet 5. The downwardly flowing milk can then be collected by, for example, a coffee cup or another vessel being placed below the fluid outlet 5.

The dispensing device 2 comprises a milk-conducting unit 19. It can be seen in FIG. 1A that a milk inlet 24 is formed on the outer side. The milk inlet 24 is provided with a closure cap in FIG. 1A. The latter is removable and a tube can be connected to the milk inlet 24 such that milk can be introduced into the milk-conducting unit 19 via the tube and the milk inlet 24. The introduced milk is then introduced into an air/milk chamber 28 via a milk supply 27. The milk is processed there via an air supply 25 to form an air/milk mixture. The air/milk mixture then enters the mixing chamber 30. This takes place by a negative pressure being produced by means of the Venturi nozzle 29. The dispensing device 2 has a steam supply 26 for the Venturi nozzle 29. The air/milk mixture is frothed in the mixing chamber 30 to form a milk froth. The milk froth or the other milk-containing fluid then leaves the milk-conducting unit 19 and the dispensing device 2 downward via the milk outlet 20 and enters there into the container 3 of the sweetening unit 1.

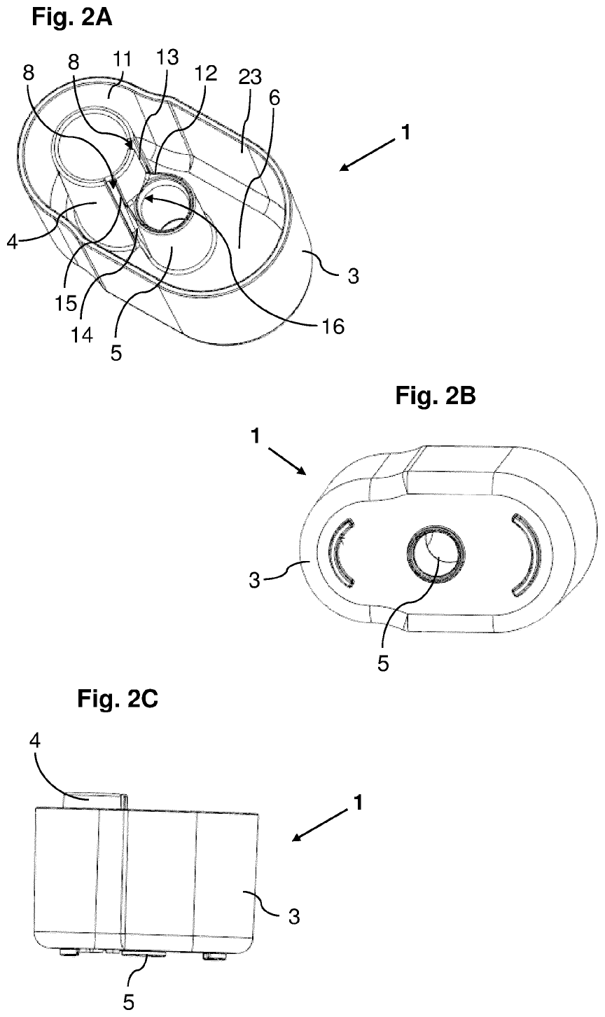

FIG. 2A to FIG. 2C show a first exemplary embodiment of a sweetening unit 1 according to the invention from different perspectives. The sweetening unit 1 comprises a container 3 into which sweetening means can be filled. The container 3 has a base 6 and laterally a border 23 which laterally completely surrounds the container 3. Walls 11 are formed on the inner side of the border 23. The container 3 is open upward.

Two upwardly protruding, cylindrical collars are formed in the container 3 at a distance from the border 23. A first collar is an inlet collar which forms a fluid inlet 4. The second collar is an overflow collar which forms a fluid outlet 5. The fluid inlet 4 is downwardly closed. The fluid inlet 4 therefore protrudes upward from the closed base and is higher than the walls 11, as can be seen in FIG. 2C. The fluid inlet 4 is upwardly open, and therefore milk-containing fluid can enter the fluid inlet 4 from above. In order to be able to emerge from the fluid inlet 4, openings forming slots 8 are formed on the lateral border thereof. The slots 8 reach here from the base as far as the upper opening of the fluid inlet 4. The slots 8 therefore extend over the entire height of the fluid inlet 4. A first sidewall 12 of the fluid outlet 5 and a second sidewall 14 of the fluid outlet 5 each adjoin a respective side edge 13, 15 of the slots 8 in a flush manner in each case. A region 16 of the fluid outlet 5 at the same time forms a region 16 of the fluid inlet 4.

The fluid outlet 5 is designed as an overflow collar. The fluid outlet 5 is open upward and downward, and therefore fluid entering from above can emerge downward. It can be seen in FIG. 2B that the fluid outlet 5 is arranged approximately in the center of the container 3. In the exemplary embodiment shown here, the diameter of the fluid outlet 5 is smaller than the diameter of the fluid inlet 4. The fluid outlet 5 has a smaller height than the fluid inlet 4. In addition, the fluid outlet 5 has a smaller height than the border 23 of the container 3. This has the result that the container 3 can be filled up to the height of the fluid outlet 5 and that the filled-up fluid then enters the fluid outlet 5 and the fluid is drained downward.

The sweetening unit 1 on account of its configuration is designed such that a fluid flow, which preferably enters the fluid inlet 4 under pressure, through the sweetening means located in the container 3 can be produced. Fluid which is pressed through the slots 8 is conducted through the container 3 filled with sweetening means and leaves the sweetening unit 1 through the fluid outlet 5. This is assisted by the container 3 being in the form of a trough.

Milk-containing fluid which is injected through the slots 8 into the container 3 or is introduced into the latter at a high speed is deflected at a wall 11 of the container 3 and, in the process, undergoes a reversal in direction and is then removed via the fluid outlet 5. Owing to the fact that the milk-containing fluid is conducted through the sweetening means, it absorbs sweetening means in metered form, and therefore the milk-containing fluid is sweetened.

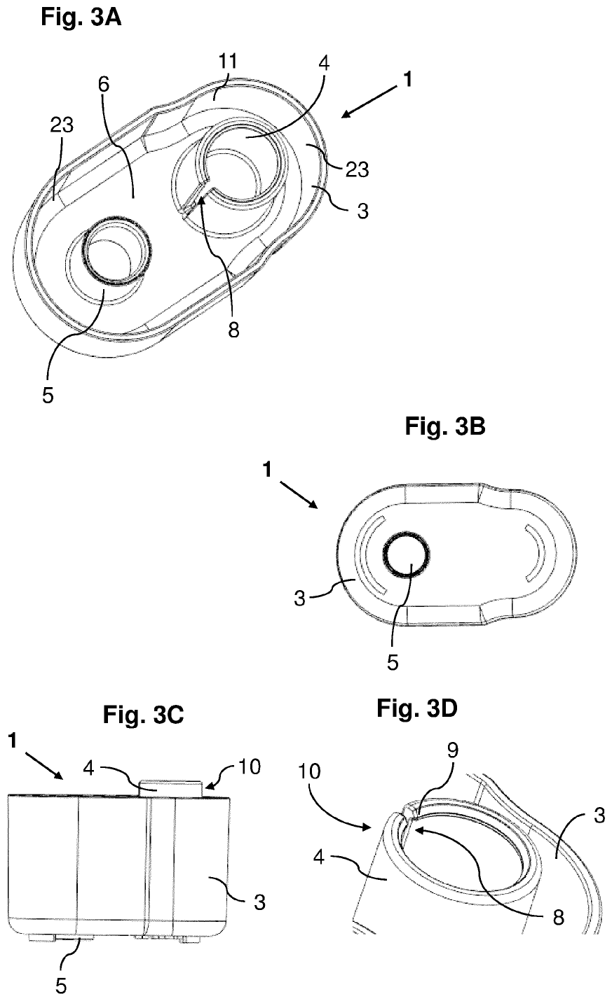

FIG. 3A to FIG. 3D show a further exemplary embodiment of a sweetening unit 1 designed according to the invention. Fluid inlet 4 and fluid outlet 5 are arranged spaced apart from each other here. The fluid outlet 5 is formed eccentrically. As can be seen from FIG. 3B, the fluid outlet 5 is at a consistent distance from a circular portion of the border 23 of the container 3. The fluid inlet 4 is also at a consistent distance from a circular portion of the border 23 of the container 3, as in particular FIG. 3A shows. It can also be stated that the fluid inlet 4 and a portion of the border 23 are arranged concentrically. The fluid outlet 5 and another portion of the border 23 are arranged concentrically as it were.

In contrast to the exemplary embodiment shown in FIG. 2A to FIG. 2C, the fluid inlet 4 laterally has only one opening which is also designed as a narrow slot 8 in this example. The slot-shaped configuration of the opening has the advantage that milk-containing fluid can be injected at a high speed into the container 3.

As can be seen from FIG. 3D, the fluid inlet 4 has, at its upper free end 10, an inwardly bent rim 9 which is beveled on the upper side. Furthermore, in the exemplary embodiment shown here, the fluid inlet 4 is of elastic design at its upper free end 10, and therefore the cross section is elastically adaptable.

The slot 8 is formed vertically. The slot 8 is formed along a central plane which divides the container 3 along its longitudinal axis into two mirror-symmetrical parts. The slot 8 is arranged such that a fluid which passes through the slot 8 is injected into the container 3 along a longitudinal axis thereof.

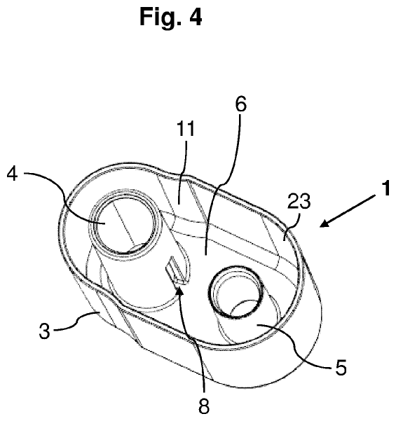

FIG. 4 shows a further exemplary embodiment of a sweetening unit 1 designed according to the invention. In contrast to the previously described exemplary embodiments, the slot 8 is not formed over the entire height of the fluid inlet 4, but rather is formed only at a lower region of the inlet collar. The slot 8 here has a height which is smaller than the height of the fluid outlet 5.

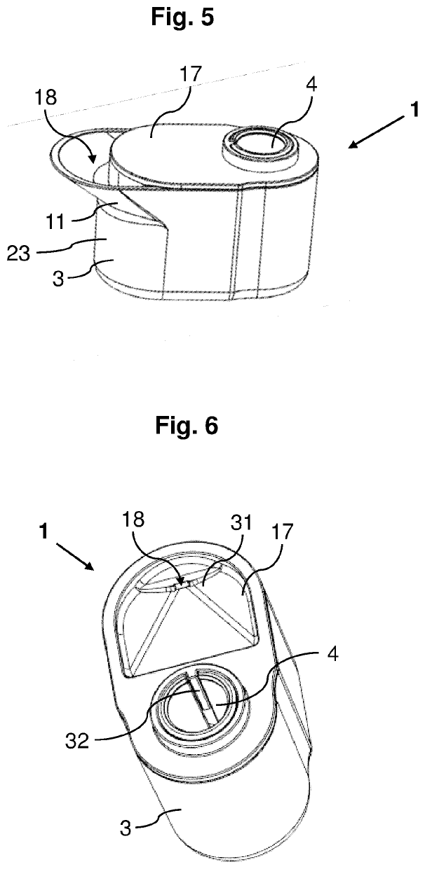

FIG. 5 and FIG. 6 show two further exemplary embodiments of sweetening units 1 designed according to the invention, wherein the sweetening units 1 are each upwardly closed by a cover 17 being placed on the container 3. The cover 17 in each case has an opening 18. In the exemplary embodiment shown in FIG. 5, the opening 18 is formed by a wall 11 of the container 3 being arched forward in a beak-shaped manner. The opening 18 is therefore formed between the border 23 or between the wall 11 and the cover 17.

An opening 18 is likewise formed in FIG. 6. In contrast to the exemplary embodiment shown in FIG. 5, said opening is formed directly in the cover 17. In the exemplary embodiment shown here, the opening 18 is formed in a hollow 31 of the cover 17. This has the advantage that filling is facilitated since the sweetening means first of all enters the hollow 31 before it is then filled into the container 3 via the opening 18. Also in the exemplary embodiment shown in FIG. 5, the opening 18 serves primarily for filling the container 3 with sweetening means.

The sweetening units 1 shown in the exemplary embodiments are suitable for different types of sweetening means, such as liquid sweetening means or else crystalline-granular sweetening means.

In the exemplary embodiment shown in FIG. 6, part of the cover 17 closes an upper region of an opening formed laterally on the fluid inlet 4. Alternatively, even in configurations which do not have a cover 17, such as the configurations in FIG. 2 and FIG. 3, the slot 8 can be partially closed, for example, by use being made of a plug-in or plug-on part which can be plugged onto the fluid inlet 4 inside and/or outside the latter.

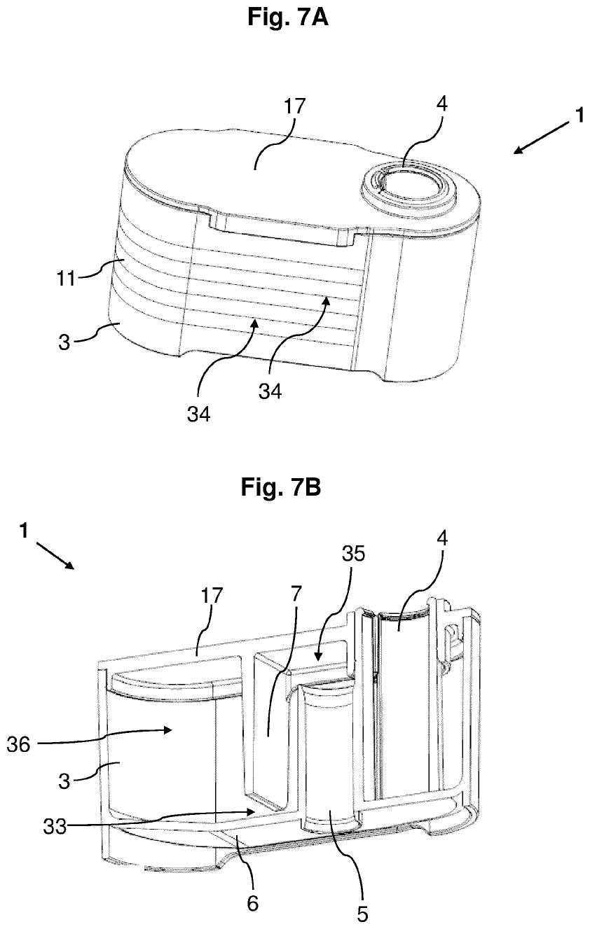

FIG. 7A to FIG. 10B show four further exemplary embodiments of sweetening units 1 designed according to the invention. The sweetening units 1 each have a cover 17 and, in addition, a partition 7 which divides the container 3 into two chambers 35 and 36. In alternative exemplary embodiments, a partition 7 can also be formed without a cover 17.

The partition 7 does not completely separate the chambers 35 and 36, but rather leaves an opening 33 which connects the two chambers 35 and 36 to each other and permits a flow of sweetening means located in the container 3 between the chambers 35 and 36. In the exemplary embodiments shown, the opening 33 is of narrow design and forms a gap.

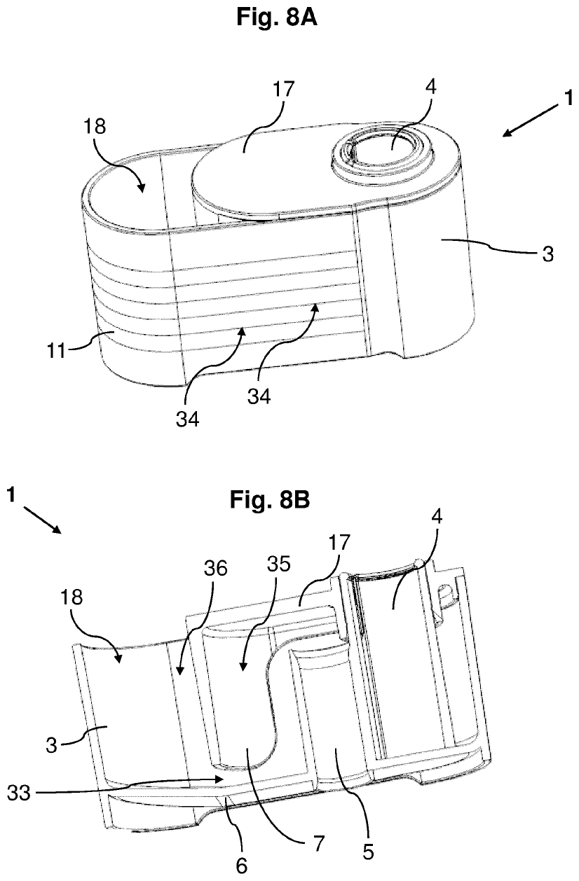

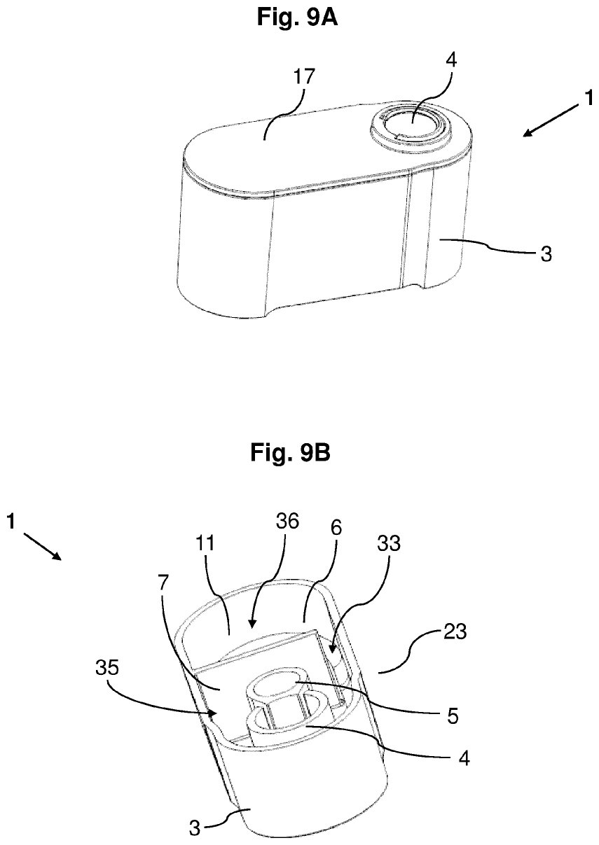

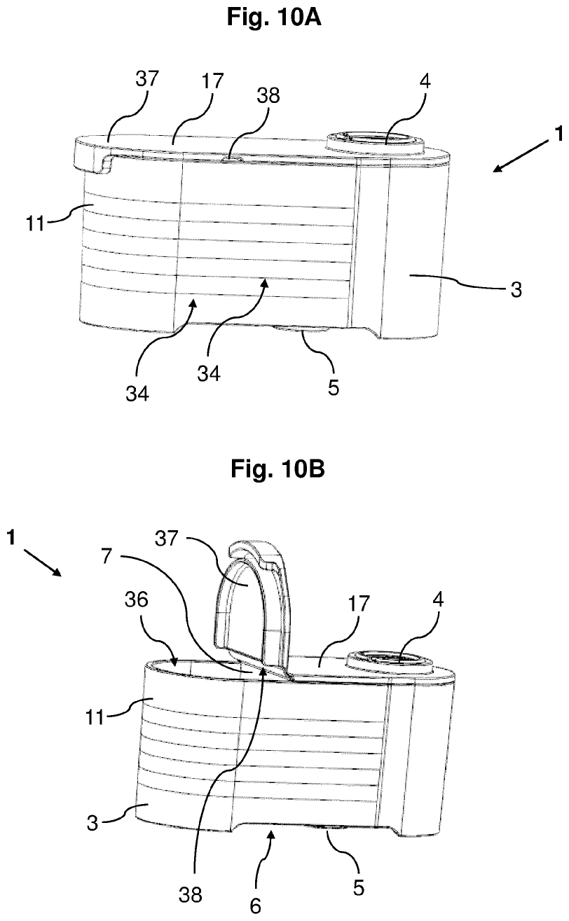

In the exemplary embodiments shown in FIG. 7, FIG. 8 and FIG. 10, the partition 7 is downwardly open, and therefore a gap remains between the base 6 of the container 3 and the partition 7. In the exemplary embodiment shown in FIG. 9, the partition 7 is opened to the side, and therefore a gap remains between the outer wall 23 of the container 3 and the partition 7. The opening 33 is formed here as far as the base 6.

In the exemplary embodiments shown in FIG. 7 and FIG. 8, the partition 7 is formed on the cover 17. In the exemplary embodiment shown in FIG. 9, the partition 7 is formed on a wall 23 of the container 3 and on the border 11 thereof.

In the exemplary embodiments shown in FIG. 7, FIG. 8 and FIG. 10, filling level lines 34 at which a filling level of the container 3 containing sweetening means can be read are formed on the outer side of the border 11 of the container 3.

In the exemplary embodiments according to FIG. 7 to FIG. 10, the fluid inlet 4 and the fluid outlet 5 are formed in the first chamber 35. No fixed structure is formed within the second chamber 36.

In the exemplary embodiment according to FIG. 8, the cover 17 ends with the partition 7, and therefore the second chamber 36 has an opening 18 upward. In the exemplary embodiments according to FIG. 7, FIG. 9 and FIG. 10, the cover 17 covers the entire container 3, and therefore the latter is completely closed upward except for the fluid inlet 4. However, the cover 17 is removable and, in FIG. 10, can be swung open, and therefore the container 3 can be filled.

In alternative exemplary embodiments, provision can be made that the cover 17 has a hinge 38 or another joint at which the cover 17 can be folded upward or opened in some other way. Such an alternatively designed cover 17 is, for example, compatible with the exemplary embodiments which are shown in FIG. 7 and FIG. 9 and in which the cover 17 completely covers the container 3. FIG. 10 shows an exemplary embodiment with a foldable cover 17. The cover 17 is of narrower design behind the partition 7, and therefore a hinge 38 is formed at the narrow point, at which hinge the cover 17 can be folded upward in particular for filling the container 3 with sweetening means. The cover 17 is therefore designed as a flap 37 behind the partition 7. FIG. 10A shows a state at which the cover 17 has been folded downward and therefore closes the container 3. FIG. 10B shows a state with an open cover 17.

The previously described exemplary embodiments of sweetening units 1 designed according to the invention are particularly readily suitable for carrying out the method according to the invention, described further above, for sweetening a milk-containing fluid.

In summary, the invention relates to a method for sweetening a milk-containing fluid, which is characterized in that the milk-containing fluid is conducted through a sweetening means. For this purpose, a sweetening unit 1 can be used for a dispensing device 2, in which a fluid inlet 4 and a fluid outlet 5 are designed in such a manner that a fluid flow through the sweetening means can be produced. It is possible for the sweetening unit 1 to be able to be placed or placed, preferably removably, on a milk outlet 20 of a milk-conducting unit 19.

### LIST OF REFERENCE SIGNS

1 sweetening unit
2 dispensing device
3 container
4 fluid inlet
5 fluid outlet
6 base of 1
7 partition
8 slot
9 rim
10 free end of 4
11 border of 1
12 first sidewall of 5
13 side edge
14 second sidewall of 5
15 side edge
16 region
17 cover
18 opening
19 milk-conducting unit
20 milk outlet
21 pivot axis
22 axis of 20
23 wall of 3
24 milk inlet
25 air supply
26 steam supply
27 milk supply
28 air-milk chamber
29 Venturi nozzle
30 mixing chamber
31 hollow
32 region of 17
33 opening in 3
34 filling level line
35 one chamber of 3
36 further chamber of 3
37 flap
38 hinge

1. A method for sweetening a milk-containing fluid, the method comprising:
providing a volume occupied by a sweetener;
conducting the milk-containing fluid through the sweetener, wherein the conducting is undertaken by the milk-containing fluid being conducted through the volume which is occupied by the sweetener, wherein the sweetener is a liquid sweetener that does not have dimensional stability.

2. The method as claimed in claim 1, wherein at least one of a) a viscosity of the milk-containing fluid is lower than a viscosity of the sweetener, or milk for forming the milk-containing fluid is first frothed before being conducted into a container which forms the volume.

3. The method as claimed in claim 1, further comprising at least one of a) injecting the milk-containing fluid into a container (3) that defines the volume such that the milk-containing fluid is conducted through the sweetener, or b) deflecting the milk-containing fluid entering the container (3) by a flow obstacle such that the milk-containing fluid undergoes a reversal in direction before emerging out of the container (3).

4. The method as claimed in claim 1, wherein at least one of a) the conducting includes the milk-containing fluid being conducted through the sweetener such that, after entering the sweetener, the milk-containing fluid leaves upward, or b) the milk-containing fluid is injected or conducted into a container (3) that forms the volume such that, upon entry, the milk-containing fluid is at least one of directed downward or does not have a speed component upward.

5. The method as claimed in claim 1, wherein the sweetener further comprises a solid.

6. The method as claimed in claim 1, wherein the sweetener is at rest when the milk-conducting fluid is conducted therein.

7. A sweetening unit (1) for a dispensing device (2) for a milk-containing fluid, the sweetening unit (1) comprises:
a container (3) for a sweetener, the container having a fluid inlet (4), a fluid outlet (5) and a base (6), wherein the fluid inlet (4) and the fluid outlet (5) are configured to allow a fluid flow through the sweetener;
wherein at least one of a) the fluid outlet (5) is configured as an overflow or b) the container (3) comprises a trough; and
the fluid inlet (4) comprises an inlet collar which protrudes upward from the base (6) and is not completely closed at a side at least in one region.

8. The sweetening unit (1) as claimed in claim 7, the fluid outlet (5) is configured as the overflow collar which protrudes upward from base (6), and is formed such that the flow can pass around the overflow collar on all sides, wherein the overflow collar is completely closed at a side thereof at least in a lower region, and is open above the closed region and at a bottom.

9. The sweetening unit (1) as claimed in claim 7, wherein at least one of a) the inlet collar (4) is open upward on an inner side and is closed downward, or b) the fluid inlet (4) has at least one slot (8) formed laterally in the inlet collar (4).

10. The sweetening unit (1) as claimed in claim 7, wherein at least one of a) the fluid inlet (4) has an inwardly bent rim (9) at an upper end thereof, or b) the fluid inlet (4) has an elastic cross section at least at a free end (10).

11. The sweetening unit (1) as claimed in claim 7, wherein at least one of a) the fluid inlet (4) protrudes upward higher than the fluid outlet (5), or b) the overflow (5) is spaced apart on all sides from a lateral border (11) of the sweetening unit (1).

12. The sweetening unit (1) as claimed in claim 7, wherein the fluid outlet (5) is configured as the overflow (5), a first sidewall (12) of the overflow (5) adjoins a side edge (13) of a first opening (8) of the fluid inlet (4) flush on an outer side.

13. The sweetening unit (1) as claimed in claim 7, further comprising a slot (8) defined in the fluid inlet (4) that is upwardly closed, wherein the fluid outlet (5) protrudes upward over the slot (8) or the slot (8) protrudes upward over the fluid outlet (5).

14. The sweetening unit (1) as claimed in claim 8, wherein the fluid inlet (4) and the fluid outlet (5) merge into each other, and a region (16) of the overflow collar (5) forms a region (16) of the inlet collar (4).

15. The sweetening unit (1) as claimed in claim 7, further comprising a cover (17) which is open in a region of the fluid inlet (4) for filling the sweetening unit (1) with the sweetener, and the cover (17) has a mechanism by which the container (3) is openable and closable.

16. The sweetening unit (1) as claimed in claim 7, further comprising a partition (7) formed in the container (3) to only partially close the container, the partition (7) leaves an opening (33) at least one of downward or laterally in the container, and the fluid inlet (4) and the fluid outlet (5) are formed on a same side of the partition (7).

17. A dispensing device (2) for a milk-containing fluid, the dispensing device comprising: a basic appliance that includes a milk-conducting unit (19) with a milk outlet (20) for a milk-containing fluid, and the sweetening unit (1) according to claim 7 connected to the milk outlet (20).

18. The dispensing device (2) as claimed in claim 17, wherein the milk-conducting unit (19) comprises a milk frothing device (2), and the sweetening unit (1) is placed on pivotably about a pivot axis (21) formed by an axis (22) of the milk outlet (20).

19. The dispensing device of claim 17, wherein the dispensing device comprises a fully automatic coffee machine.
